(19) United States
(12) Patent Application Publication
(10) Pub. No.: US 2007/0206342 A1
(43) Pub. Date: Sep. 6, 2007

(54) High Dielectric, Non-Linear Nano-Capacitor

(76) Inventors: Andrew L. Tipton, Des Moines, IA (US); Arthur V. Pohm, Ames, IA (US); Carl L. Tipton, Ames, IA (US)

Correspondence Address: ANDREW TIPTON, 320 NW UPTOWN TERRACE, UNIT 1A, PORTLAND, OR, 97210, US

(21) Appl. No.: 11/308,081

(22) Filed: Mar. 6, 2006

(51) Int. Cl. H01G 4/20

(52) U.S. Cl. 361/312

(57) ABSTRACT

A solid-state, low-voltage, non-linear nano-capacitor is described comprising a self-organized monolayer between two electrodes. The monolayer comprises an electron donor and electron acceptor separated by a conjugated bridge.

### FIELD OF THE INVENTION

This invention relates in general to the field of solid-state capacitors, and more particularly, to high dielectric, non-linear nano-capacitors. A capacitor is an energy storage device that stores an applied electrical charge for a period of time, then discharges it. It is charged by applying a voltage across two electrodes and discharged by shorting the two electrodes. A voltage is maintained until discharge even when the charging source is removed. A capacitor blocks the flow of direct current and permits the flow of alternating current. The energy density of a capacitor is usually less than for a battery, but the power output of a capacitor is usually higher than for a battery. Capacitors are used for various purposes including timing, power supply smoothing, coupling, filtering, tuning and energy storage. Batteries and capacitors are often used in tandem such as in a camera with a flash. The battery charges the capacitor that then provides the high power needed for a flash. The same idea works in electric and hybrid vehicles where batteries provide energy and capacitors provide power for starting and acceleration.

Two main types of capacitors are non-electrolytic and electrolytic. A non-electrolytic capacitor is non-polarized and can be connected either way in a circuit and often consists of two conductors such as parallel metal plates that are insulated from one another with a dielectric. An electrolytic capacitor is polarized and must be connected to the circuit in a specific way.

An electrochemical capacitor, also known as an electrochemical double-layer capacitor, supercapacitor or ultracapacitor, consists of high surface area electrodes separated by an ionically conductive electrolyte. The surface area of an electrode, often porous carbon, is on the order of 1000 m²/g. Most of the surface of the electrode cannot be accessed mechanically, but can be accessed by a liquid electrolyte. The energy density of an electrochemical capacitor is higher than that of traditional non-electrolytic and electrolytic capacitors, but still lower than that of a battery. Conversely, the power output of an electrochemical capacitor is lower than that of traditional non-electrolytic and electrolytic capacitors, but higher than that of a battery. Moreover, an electrochemical capacitor discharges slower than traditional non-electrolytic and electrolytic capacitors.

A need exists to improve the energy density of capacitors while maintaining the existing power output. There exists a further need to provide a capacitor featuring a high dielectric constant sustainable to high frequencies where the capacitance is voltage dependent. Such a capacitor is the subject of the present invention. The capacitor of the present invention builds on past work on nanotechnology, self-assembled monolayers and non-linear optical chromophores.

In high frequency applications, it is often important that the capacitors used do not have high dielectric losses. In the case of ferroelectric ceramic capacitors with a high dielectric constant, the presence of domain boundaries and electrostriction provide loss mechanisms that are significant. In contrast, the high dielectric mechanism disclosed in this invention involves the movement of an electron in a long molecule and its fixed donor. This occurs extremely rapidly so that losses even at gigahertz frequencies are small.

A second very useful property of the type of capacitor disclosed in the invention is its non-linearity. In many applications, it is desirable to have a voltage sensitive capacitance to tune circuits and adjust filters. The disclosed capacitors have such a property; as the mobile electron moves to the far end of the non-linear dielectric molecule as the voltage increases, its motion is stopped so that with additional voltage little change in position occurs. As a consequence, the increase in the electric moment of the dielectric is reduced resulting in a diminished dielectric constant.

### SUMMARY OF THE INVENTION

One aspect of the present invention is to provide a capacitor with a high power output. A further aspect of the present invention is to provide a capacitor featuring a high dielectric constant sustainable to high frequencies. A still further aspect of the present invention is to provide a capacitor featuring voltage dependent capacitance. In yet another aspect of the present invention, a method to make such a capacitor is provided.

The capacitor, in its simplest form, comprises a first electrode, a second electrode and a non-linear dielectric molecule between the first electrode and the second electrode. The non-linear dielectric molecule further comprises an electron donor and an electron acceptor separated by a conjugated bridge. The conjugated bridge comprises one or more double bonds that alternate with single bonds in an unsaturated compound. Among the many elements that may be present in the double bond, carbon, nitrogen, oxygen and sulfur are the most preferred. The π electrons in the conjugated bridge are delocalized across the length of the bridge. When a bias is applied across the first and second electrodes, the non-linear dielectric molecule becomes more or less polarized with electron density moving from the donor to acceptor or vice versa. When the bias is removed, the original charge distribution is restored.

A preferred non-linear dielectric molecule further comprises a first insulator between the first electrode and the first electron donor or acceptor, a second insulator between the second electrode and the second electron donor or acceptor and a first connector attaching the first insulator to the first electrode. Optionally, a second connector may attach the second insulator to the second electrode.

The insulators at each end of the molecule prevent a short circuit as the conjugated bridge is electrically conductive. The insulators may be the same or different and may be selected from any insulating groups known in the art. Preferred insulators include, but are not limited to, substituted or unsubstituted alkyl, haloalkyl, ether, silane, siloxane and phosphazene groups and combinations thereof. More preferred insulators are selected from the group consisting of alkyl and fluoroalkyl groups and combinations thereof. Alternatively, the surface of one or both electrodes may be insulating, and thus allowing the use of molecules with shorter insulators or no insulators at all.

Preferred electron donors include, but are not limited to, amino and phosphino groups and combinations thereof. Preferred electron acceptors include, but are not limited to, nitro, carbonyl, oxo, thioxo, sulfonyl, malononitrile, isoxazolone, cyano, dicyano, tricyano, tetracycano, nitrile, dicarbonitrile, tricarbonitrile, thioxodihydropyrimidinedione groups and combinations thereof. More conjugated bridges include, but are not limited to, 1,2-diphenylethene, 1,2-diphenyidiazene, styrene, hexa-1,3,5-trienylbenzene and 1,4-di(thiophen-2-yl)buta-1,3-diene, alkenes, dienes, trienes, polyenes, diazenes and combinations thereof. Particularly preferred conjugated bridges include alkenes, dienes, trienes and polyenes.

The non-linear dielectric molecule is either bonded to one electrode, bonded to both electrodes or is not bonded to either electrode. The non-linear dielectric molecule is more preferably bonded to an electrode through a connector selected from the group consisting of boron, carbon, nitrogen, oxygen, silicon, phosphorus, sulfur, selenium, tellurium and combinations thereof. The non-linear dielectric molecule is more preferably bonded to the electrode through a connector selected from the group consisting of sulfur and selenium. The non-linear dielectric molecule is most preferably bonded to the electrode through a sulfur atom, forming a thiol linkage. Preferred groups that contain a connector are selected from the group consisting of alcohols, alkyl halides, alkoxides, alkyl carboxylates, thiols, selenothiols, silanols, silicon halides, silicon alkoxides, silicon carboxylates, borates, phosphinates, phosphonates and combinations thereof. More preferred groups include the thiols, —SH, —C(SH)₂, —NC(SH)₂ and the selenium analogues.

The surface of one or both electrodes is selected from the group consisting of conductors, semiconductors and insulators. Conductors include, but are not limited to, metals, conducting polymers and graphite. Semiconductors include, but are not limited to, silicon, germanium, silicon carbide, gallium arsenide and selenium. Insulators include, but are not limited to, metal oxides, non-metal oxides, metal hydroxides, non-metal hydroxides, metal halides, non-metal halides, metal hydrides and non-metal hydrides. Preferred electrode surfaces include, but are not limited to, the conductors copper, silver, gold, aluminum, titanium, palladium, platinum, nickel, zinc, tin, and conducting polymers and the semiconductors silicon and gallium arsenide. In one preferred embodiment, the electrode surface is Au(111). A Au(111) surface is preferably obtained from the evaporation of a thin gold film onto a flat support. Flat supports include, but are not limited to, glass, plastic, silicon and metal surfaces.

Non-linear dielectric molecules containing thiol groups bond to the Au(111) surface from solution and create a dense monolayer with the non-linear dielectric molecules pointing outward from the Au(111) surface. The second electrode is applied on top of this self-assembled monolayer.

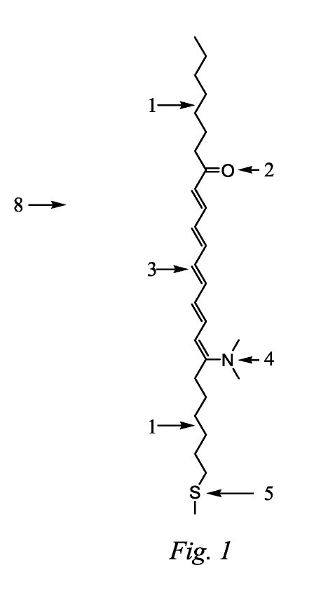

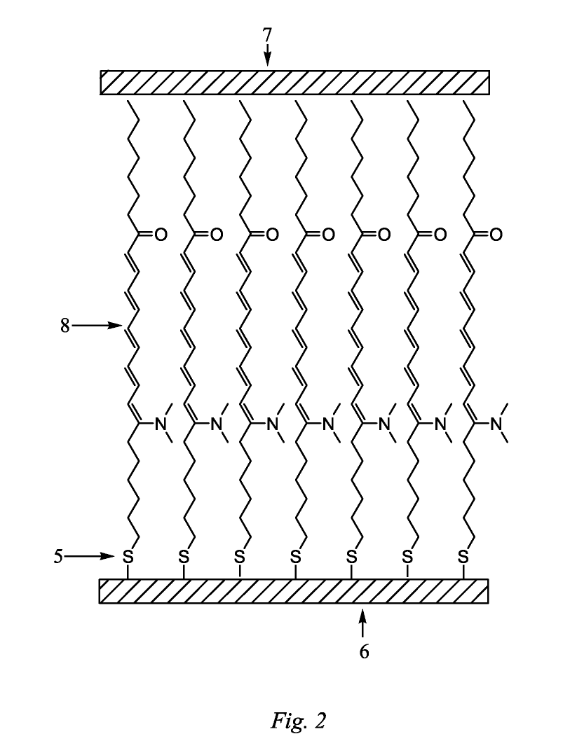

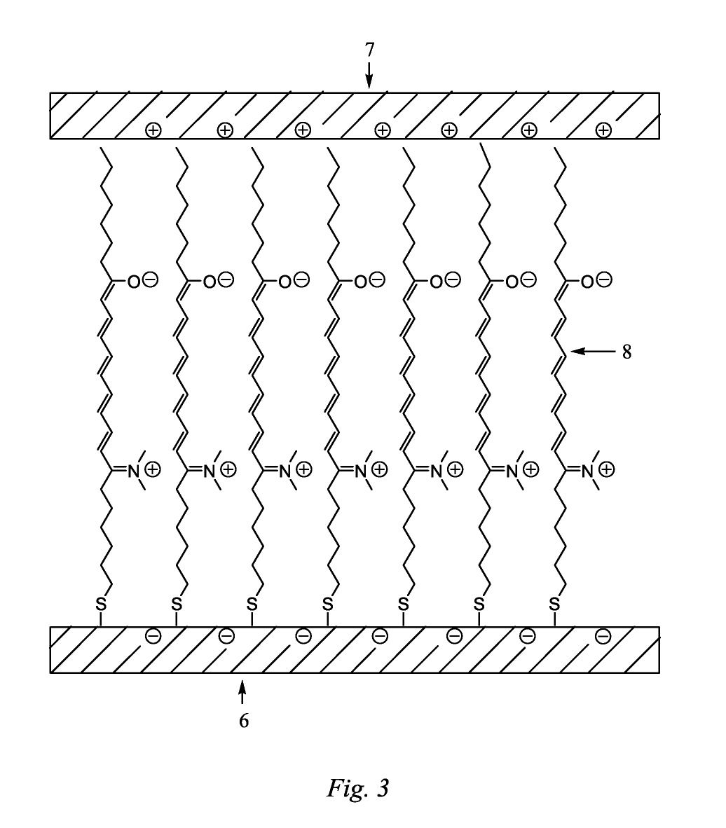

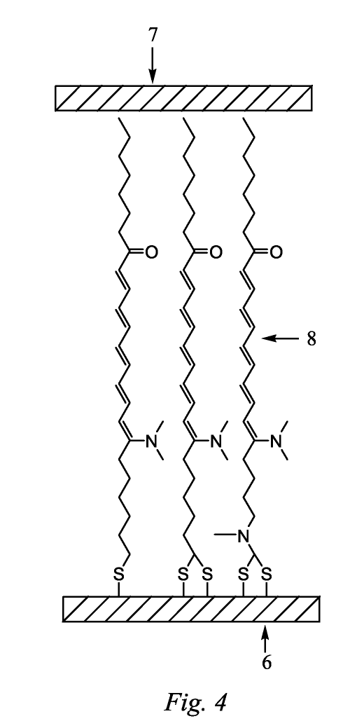

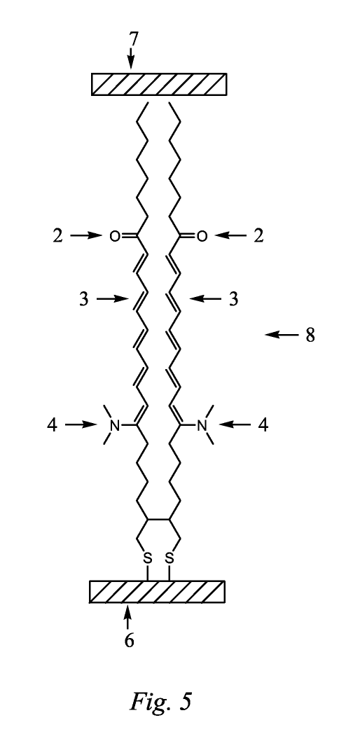

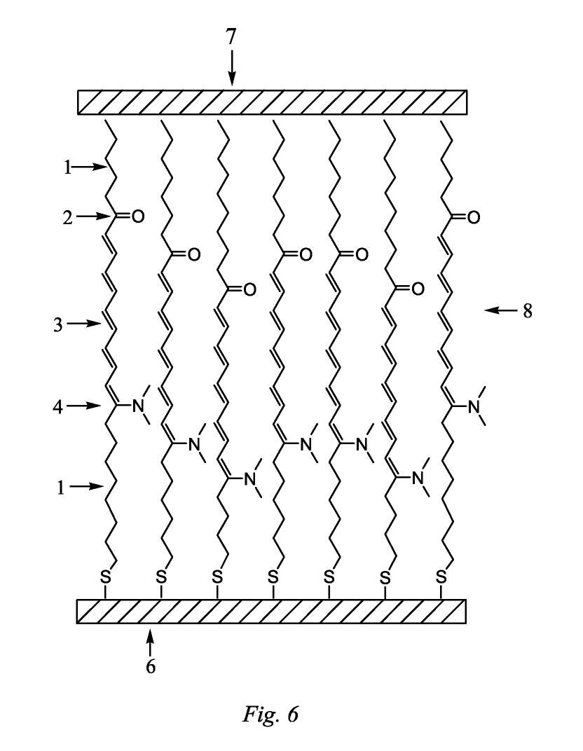

FIG. 1 illustrates the components in a non-linear dielectric molecule 8, a connector 5, an insulator 1, an electron donor 4, a conjugated bridge 3, an electron acceptor 2 and an insulator 1. The illustrated molecule is a preferred non-linear dielectric molecule 8. FIG. 2 illustrates a two-dimensional array of non-linear dielectric molecules 8 anchored by thiol linkage connectors 5 to the first electrode 6 with the second electrode 7 deposited on top. The array of non-linear dielectric molecules 8 is typically three-dimensional. FIG. 3 illustrates the change in polarity of the non-linear dielectric molecules 8 under a bias. FIG. 4 illustrates that a non-linear dielectric molecule 8 may have more than one bond to the first electrode 6. FIG. 5 illustrates that a non-linear dielectric molecule 8 may have more than one electron donor 4, electron acceptor 2 and conjugated bridge 3. FIG. 6 illustrates that the array of non-linear dielectric molecules 8 may comprise a mixture of molecules. One advantage of a mixture of molecules is lowering the electron donor 4 to donor and electron acceptor 2 to acceptor intermolecular repulsions. The lengths of the insulators 1 and conjugated bridges 3 are adjustable, however, the total length of each non-linear dielectric molecule 8 is preferably the same.

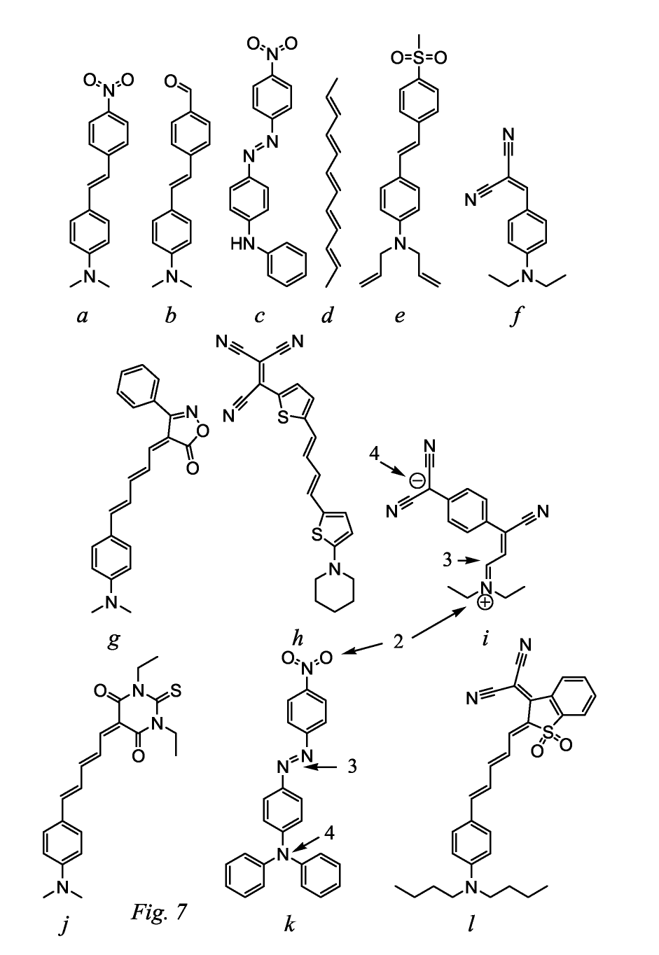

FIGS. 7(a) to (l) illustrate preferred electron donor 4, conjugated bridge 3, electron acceptor 2 combinations for non-linear dielectric molecules 8: N,N-dimethyl-4-(4-nitrostyryl)aniline (a), 4-(4-(dimethylamino)styryl)benzaldehyde (b), 4-((4-nitrophenyl)diazenyl)-N-phenylaniline (c), dodeca-2,4,6,8,10-pentaene (d), N,N-diallyl-4-(4-(methylsulfonyl)styryl)aniline (e), 2-(4-(diethylamino)benzylidene)malononitrile (f), 4-(5-(4-(dimethylamino)phenyl)penta-2,4-dienylidene)-3-phenylisoxazol-5-one (g), 2-(5-(4-(5-(piperidin-1-yl)thiophen-2-yl)buta-1,3-dienyl)thiophen-2-yl)ethene-1,1,2-tricarbonitrile (h), dicyano(4-(1-cyano-3-(diethyliminio)prop-1-enyl)phenyl)methanide (i), 5-(5-(4-(dimethylamino)phenyl)penta-2,4-dienylidene)-1,3-diethyl-2-thioxodihydropyrimidine-4,6-dione (j), 4-((4-nitrophenyl)diazenyl)-N,N-diphenylaniline (k) and unknown name (l). Other preferred molecules with electron donors and electron acceptors separated by conjugated bridges (also known as non-linear optical (NLO) chromophores) include (2,6-Dimethyl-4H-pyran-4-ylidene)malononitrile, (S)-(−)-1-(4-Nitrophenyl)-2-pyrrolidinemethanol, [4-[Bis(2-hydroxyethyl)amino]phenyl]-1,1,2-ethylenetricarbonitrile, 1-Docosyl-4-(4-hydroxystyryl)pyridinium bromide, 2-(Dimethylamino)vinyl-1-nitronaphthalene, 2,3,5,6-Tetrafluoro-7,7,8,8-tetracyanoquinodimethane, 4-[4-(Dimethylamino)styryl]-1-methyl pyridinium p-toluenesulfonate, 2-[[5-(Dibutylamino)-2-thienyl]methylene]-1H-indene-1,3(2H)-di one, 2-[4-((4-(Bis(2-hydroxyethyl)amino]phenyl)(cyano)methylene]-2,5-cyclohexadien-1-ylidene]malonitrile, 2-[4-(Dimethylamino)styryl]pyridine, 2-[Ethyl[4-[2-(4-nitrophenyl)ethenyl]phenyl]amino]ethanol, 2-Amino-3-nitropyridine, 2-Amino-5-nitropyridine, 2-Aminofluorene, 2-Chloro-3,5-dinitropyridine, 2-Chloro-4-nitroaniline, 2-Methyl-4-nitroaniline, 2-Nitroaniline, 3-[(4-Nitrophenyl)azo]-9H-carbazole-9-ethanol, 3-Methyl-4-nitropyridine N-oxide, 3-Nitroaniline, 4-(Dibenzylamino)benzaldehyde-N,N-diphenylhydrazone, 4-[4-(Dimethylamino)styryl]-1-docosylpyridinium bromide, 4-[4-(Dimethylamino)styryl]pyridine, 4-Dimethylamino-4′-nitrostilbene, 4-Nitroaniline, 5-Nitroindole, 5-Nitrouracil, 7,7,8,8-Tetracyanoquinodimethane, 9-Ethyl-3-carbazolecarboxaldehyde-N-methyl-N-phenylhydrazone, Disperse Orange 25, Disperse Orange 3, Disperse Red 1, Disperse Red 13, Disperse Red 19, Disperse yellow 7, Ethyl 4-(dimethylamino)benzoate, Gentian Violet, N-(2,4-Dinitrophenyl)-L-alanine methyl ester, N,N-Dimethyl-N¢-[(5-nitro-2-thienyl)methylene]-1,4-phenylenediamine, N-[3-Cyano-3-[4-(dicyanomethyl)phenyl]-2-propenylidene]-N-ethyl-ethaniminium inner salt, Nile Blue A, N-Methyl-4-nitroaniline, trans-4-[4-(Dimethylamino)styryl]-1-methylpyridinium iodide and trans-4-[4-(Dimethylamino)styryl]-1-methylpyridinium p-toluenesulfonate.

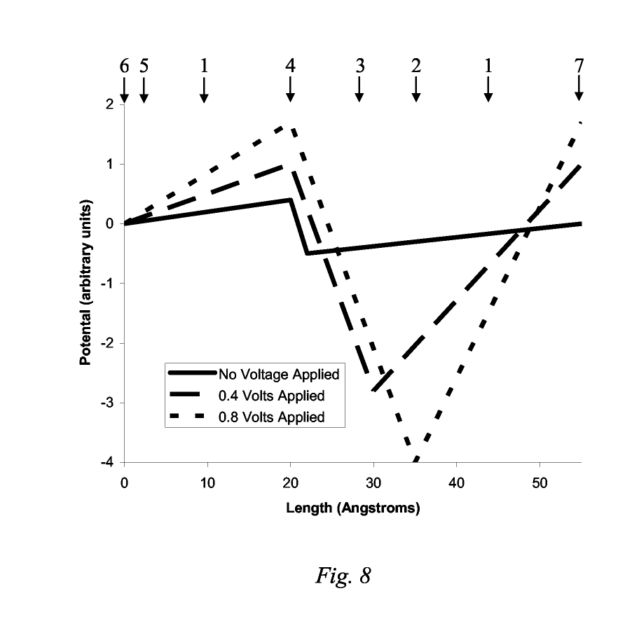

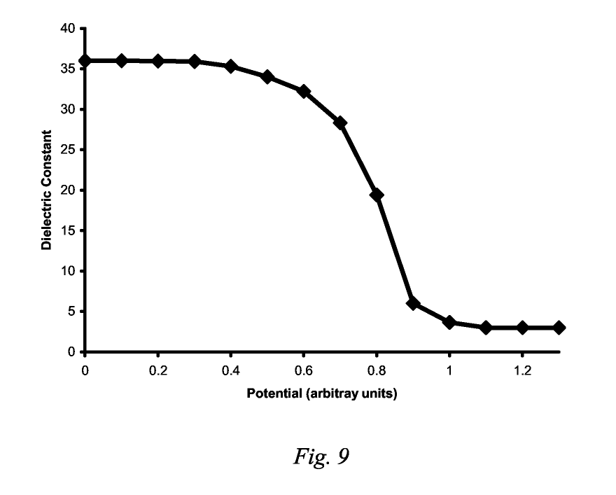

FIG. 8 illustrates the change in the potential as the electric moment increases with applied potential. A non-linear dielectric molecule (not shown) is between the first electrode 6 and the second electrode 7. The positions of the connector 5, an insulator 1, the electron donor 4, the conjugated bridge 3, the electron acceptor 2, and an insulator 1 are shown with arrows at the top of the Figure. The mobile electron is between the electron donor 4 and the electron acceptor 2. FIG. 9 illustrates that the dielectric constant of a non-linear dielectric molecule varies with voltage. After the non-linear dielectric molecule is fully polarized, the dielectric constant remains at a constant low value.

In one embodiment, the non-linear dielectric molecule comprises more than one electron donor-conjugated bridge-electron acceptor combination in series in order to achieve higher capacitor voltages. The combinations may be separated by insulators. In another embodiment, the non-linear dielectric molecules are stacked in two or more layers to achieve higher capacitor voltages. For example, a first (mono) layer of non-linear dielectric molecules is bonded to the first electrode. A second layer, such as gold, is placed onto the first layer. A third (mono) layer of non-linear dielectric molecules is bonded to the second layer and so on until the second electrode is placed on top of a layer to terminate the stacking.

Capacitors of the present invention are made by placing a first electrode in contact with a solution containing the non-linear dielectric molecule until a monolayer of the molecule bonds to the electrode surface, rinsing the first electrode and monolayer with solvent to remove excess non-linear dielectric molecule, drying the structure and placing a second electrode on top of the monolayer opposite the first electrode. The concentration of the non-linear dielectric molecule solution is preferably between 0.01 mM and 100 mM and most preferably, the non-linear dielectric molecule is dissolved in 0.1 M NaOH water/ethanol (1:1, v/v) at a concentration of 0.5 mM. The range of time the first electrode is in contact with the non-linear dielectric molecule solution is from approximately 1 minute to approximately 72 hours, and preferably from approximately 10 hours to approximately 25 hours, and most preferably from approximately 12 hours to approximately 17 hours. In one embodiment, the time the first electrode is in contact with the non-linear dielectric molecule solution is approximately 15 hours. The structure is preferably rinsed with water and then ethanol. The structure is preferably dried with an inert gas such as helium, argon, neon, and combinations thereof. The second electrode is preferably deposited by vapor deposition.

Alternatively, the non-linear dielectric molecule is brought into contact with the first electrode from the gas phase. The pressure of the gas phase is preferably between approximately 10⁻⁶ mbar and approximately 400 mbar. The process temperature is preferably between approximately 20° C. and approximately 200° C. The deposition time ranges from approximately 10 seconds to approximately 48 hours.

If there is a defect (vacancy) in the array of non-linear dielectric molecules on the first electrode, deposition of the second electrode on top of the array may result in a short circuit. However, the non-linear dielectric molecules often are non-perpendicular to the first electrode surface. One reason is that non-linear dielectric molecules tilt to maximize van der Waals forces between adjacent molecules. As a result, the tilted non-linear dielectric molecules prevent short-circuits by covering defects on the first electrode. Alternatively, an insulator followed by a conductor (comprising the second electrode) is deposited onto the array of non-linear dielectric molecules. The insulator covers all the defects. In this instance, it is often unnecessary to include the second insulator in the non-linear dielectric molecule.

1. A capacitor comprising:
a first electrode;
a second electrode; and
a non-linear dielectric molecule between the first electrode and the second electrode, wherein the non-linear dielectric molecule comprises an electron donor and an electron acceptor separated by a conjugated bridge, and the electron donor and electron acceptor are separated by more than four atoms.

2. The capacitor of claim 1 further comprising a plurality of non-linear dielectric molecules.

3. The capacitor of claim 1 further comprising a mixture of non-linear dielectric molecules.

4. The capacitor of claim 1, wherein the non-linear dielectric molecule further comprises an insulator at one end.

5. The capacitor of claim 1 wherein the non-linear dielectric molecule further comprises more than one electron donor-conjugated bridge-electron acceptor combination in series.

6. The capacitor of claim 1, wherein the non-linear dielectric molecule further comprises an insulator at both ends.

7. The capacitor of claim 4 wherein the insulator is selected from the group consisting of substituted and unsubstituted alkyl, haloalkyl, ether, silane, siloxane, phosphazene groups and combinations thereof.

8. The capacitor of claim 6 wherein the insulators are independently selected from the group consisting of functionalized and unfunctionalized alkyl, haloalkyl, ether, silane, siloxane and phosphazene groups and combinations thereof.

9. The capacitor of claim 1 wherein the conjugated bridge is selected from the group consisting of alkenes, dienes, trienes, polyenes, 1,2-diphenylethene, 1,2-diphenyldiazene, styrene, hexa-1,3,5-trienylbenzene, 1,4-di(thiophen-2-yl)buta-1,3-diene and combinations thereof.

10. The capacitor of claim 1, wherein the non-linear dielectric molecule is attached to the first electrode through a connector selected from the group consisting of boron, carbon, nitrogen, oxygen, silicon, phosphorus, sulfur, selenium, tellurium and combinations thereof.

11. The capacitor of claim 1 wherein the electron donor is selected from the group consisting of amino, phosphino groups and combinations thereof.

12. The capacitor of claim 1 wherein the electron acceptor is selected from the group consisting of nitro, carbonyl, oxo, thioxo, sulfonyl, malononitrile, isoxazolone, cyano, dicyano, tricyano, tetracycano, nitrile, dicarbonitrile, tricarbonitrile, thioxodihydropyrimidinedione groups and combinations thereof.

13. The capacitor of claim 1 wherein the electron donor is an amino group, the electron acceptor is selected from the group consisting of nitro, carbonyl and cyano groups and the conjugated bridge is selected from the group consisting of alkenes, dienes, trienes and polyenes.

14. The capacitor of claim 1 wherein the capacitor features a high dielectric constant sustainable to high frequencies and the capacitance is voltage sensitive.

15. A method for making a capacitor comprising:
(a) depositing a first layer wherein the first layer comprises a material that bonds to non-linear dielectric molecules; and
(b) bonding a second layer to the first layer wherein the second layer comprises a monolayer of non-linear dielectric molecules wherein the non-linear dielectric molecule comprises an electron donor and an electron acceptor separated by a conjugated bridge, and the electron donor and electron acceptor are separated by more than four atoms.

16. The method of claim 15 further comprising:
(c) rinsing the second layer with solvent to remove excess non-linear dielectric molecules; and
(d) drying the second layer.

17. The method of claim 15 further comprising: repeating steps (a) and (b) a number of times to build a multilayer capacitor.

18. A capacitor comprising:
a first electrode with a gold surface;
a second electrode; and
a non-linear dielectric molecule bonded to the gold surface, wherein the non-linear dielectric molecule comprises an electron acceptor and an electron donor separated by a conjugated bridge, wherein the electron donor and electron acceptor are separated by more than four atoms, and the electron donor is an amino group.

19. A multilayer capacitor comprising:
a first electrode;
a first layer bonded to the first electrode wherein the first layer comprises a monolayer of non-linear dielectric molecules;
a second layer applied on top of the first layer, wherein the second layer comprises a material that bonds to non-linear dielectric molecules;
a third layer bonded to the second layer, wherein the third layer comprises a monolayer of non-linear dielectric molecules; and
a second electrode.

20. The multilayer capacitor of claim 19 further comprising a plurality of second layers and a plurality of third layers.
